(19) United States
(12) Patent Application Publication
(10) Pub. No.: US 2020/0346406 A1
(43) Pub. Date: Nov. 5, 2020

(54) RECEPTACLE TO HOLD A POWDER

(71) Applicant: HEWLETT-PACKARD DEVELOPMENT COMPANY, L.P., Spring, TX (US)

(72) Inventor: Brent Ewald, Vancouver, WA (US)

(21) Appl. No.: 16/608,224

(22) PCT Filed: Jan. 19, 2018
(86) PCT No.: PCT/US2018/014462

§ 371 Date: Oct. 25, 2019

(51) Int. Cl. B29C 64/255; B33Y 30/00; B33Y 40/00; B29C 64/329; B29C 64/386; B33Y 50/00

(52) U.S. Cl. CPC B29C 64/255; B33Y 30/00; B33Y 50/00; B29C 64/329; B29C 64/386; B33Y 40/00

(57) ABSTRACT

In one example, a powder holding system includes a receptacle having an interior to contain a column of powder and a meter to measure a shear force exerted on the interior of the receptacle by the column of powder.

### BACKGROUND

Additive manufacturing machines produce 3D objects by building up layers of material. Some additive manufacturing machines are commonly referred to as “3D printers.” 3D printers and other additive manufacturing machines make it possible to convert a CAD (computer aided design) model or other digital representation of an object into the physical object. The model data may be processed into slices defining that part of a layer or layers of build material to be formed into the object.

### DRAWINGS

FIG. 1 is a block diagram illustrating an example of a powder holding system such as might be used for a build material supply in an additive manufacturing machine.

FIGS. 2-6 illustrate one example of a receptacle and meter such as might be implemented in a powder holding system shown in FIG. 1.

FIG. 7 is a block diagram illustrating one example of a powder supply control system such as might be used to control the flow of powder into and out of the receptacle shown in FIGS. 2-6.

FIGS. 8 and 9 illustrate another example of a receptacle and meter such as might be implemented in a powder holding system shown in FIG. 1.

FIG. 10 is a block diagram illustrating one example of a powder supply control system such as might be used to control the flow of powder into and out of the receptacle shown in FIGS. 8 and 9.

FIGS. 11 and 12 illustrate another example of a receptacle and meter such as might be implemented in a powder holding system shown in FIG. 1.

FIGS. 13-16 illustrate another example of a receptacle and meter such as might be implemented in a powder holding system shown in FIG. 1.

The same part numbers designate the same or similar parts throughout the figures. The figures are not necessarily to scale.

### DESCRIPTION

In some additive manufacturing processes, a powdered build material is used to form a solid object. Powder in each layer of build material is fused in a pattern according the corresponding object slice. One of the challenges of additive manufacturing with powdered build materials is effectively controlling the supply of build material powder to the manufacturing area. A new sensing system has been developed to help determine the amount of powder in a build material supply hopper by measuring a shear force exerted on the interior of the hopper by the column of powder inside the hopper. The new sensing system takes advantage of that fact that a column of powder transfers its weight to the walls of a hopper or other container as a function of the height of the column. In a cylindrical container, for example, the powder transfers nearly all of it weight to the container after the column reaches about two diameters in height.

The powder shear force may be measured directly to determine the amount of powder in the hopper, for example by embedding flexible panels vertically along the interior surface of the hopper. Each panel is flexible in the direction of the shear force exerted on the interior of the hopper by the powder. Sensors operatively connected to each panel sense the shear forces vertically along the interior of the hopper to determine the amount of powder. Alternately, the shear force may be measured indirectly using a scale to weigh the powder in the hopper without also weighing the hopper itself. The scale may be implemented, for example, by lining the hopper with a vertically oriented inner wall suspended from the outer wall and then measuring shear between the inner wall and the outer wall or by measuring the displacement of the inner wall relative to the outer wall. The weight of the powder, and thus the amount of powder in the hopper, can be determined as a function of the shear or displacement. Measuring the amount of powder inside the hopper without also measuring the weight of the hopper itself avoids the difficulty of accounting for the forces exerted on the hopper by conduits, valves, connectors and other external components, to help more accurately determine the amount of powder in the hopper for better control of the supply of build material powder to the manufacturing area.

These and other examples described below and shown in the figures illustrate but do not limit the scope of the patent, which is defined in the Claims following this Description.

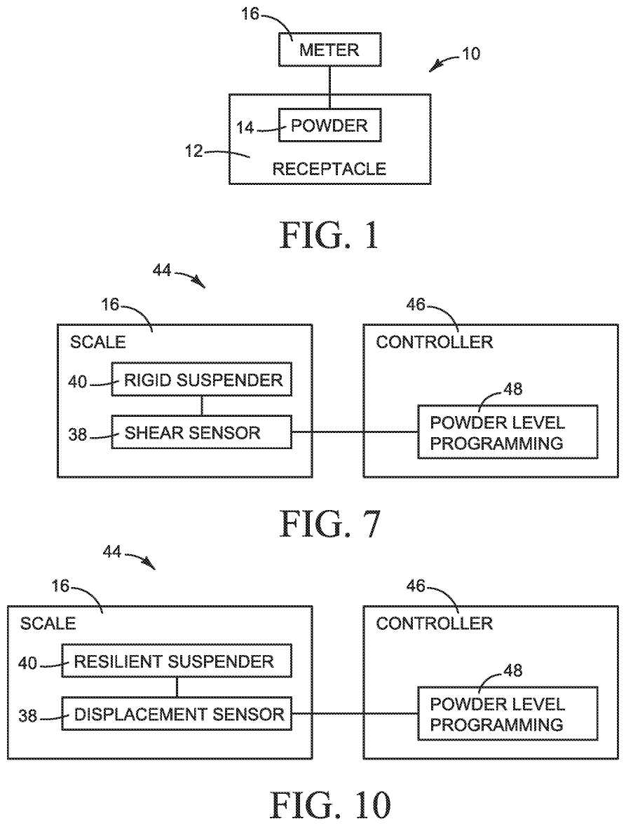

FIG. 1 is a block diagram illustrating one example of a powder holding system 10 such as might be used for a build material supply in an additive manufacturing machine. Referring to FIG. 1, powder holding system 10 includes a hopper or other receptacle 12 to hold a build material or other powder 14 and a meter 16 to measure a shear force exerted on the interior of receptacle 12 by a column of powder 14

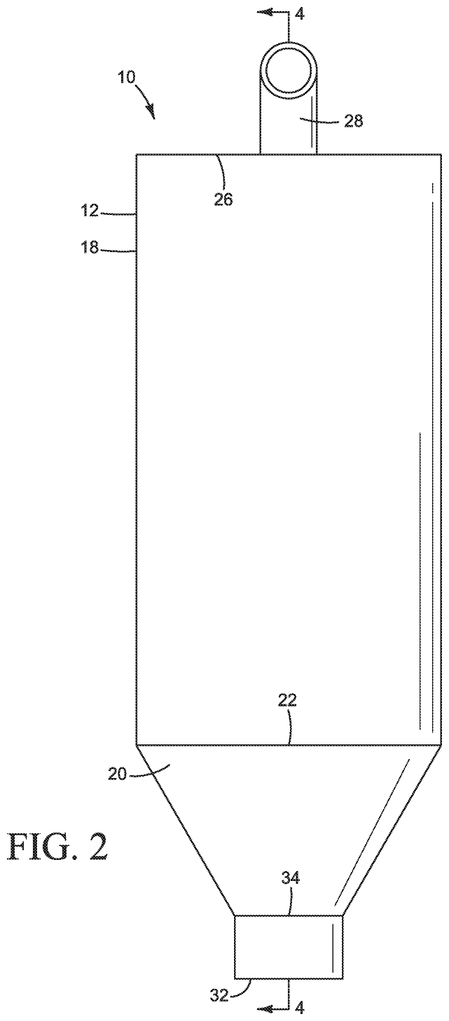

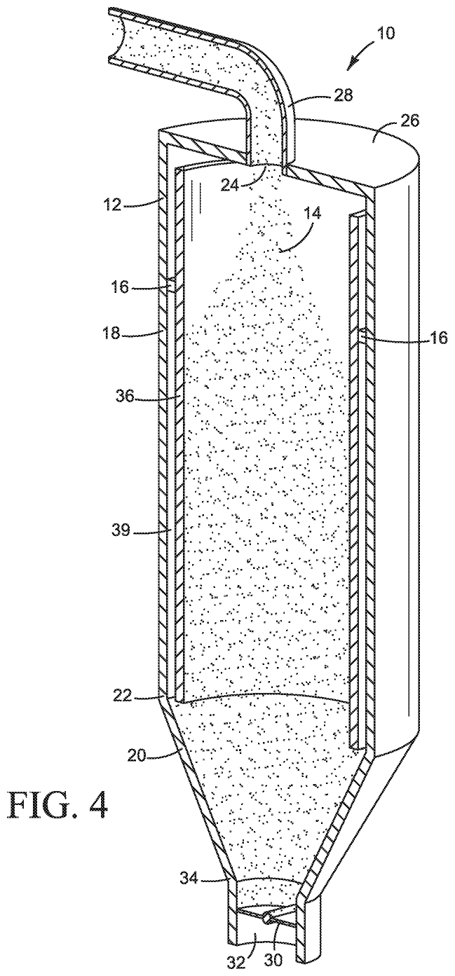

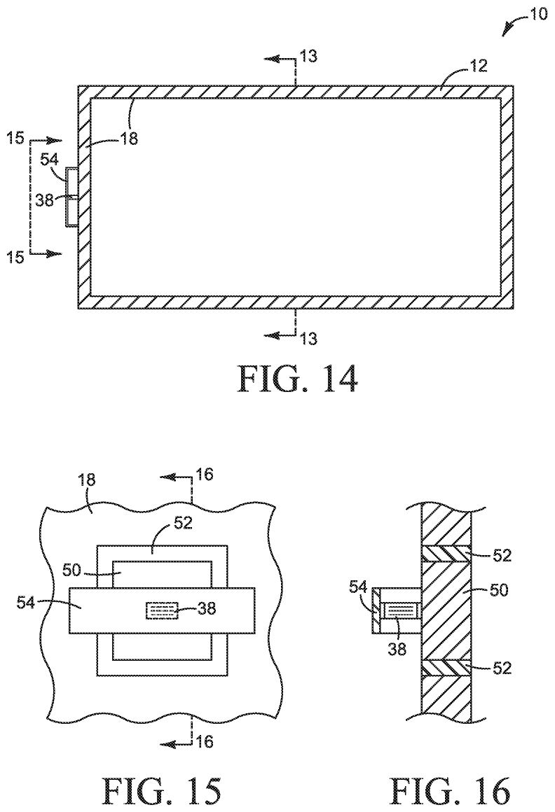

FIGS. 2-6, 8-9, 11-12, and 13-16 illustrate examples for implementing a meter 16 in the powder holding system 10 shown in FIG. 1. Referring to the example shown in FIGS. 2-6, powder holding system 10 includes a cylindrical hopper 12 to hold powder 14 and a meter 16 to measure the amount of powder 14 in hopper 12. Powder 14 is shown in the section view of FIG. 4. Although a cylindrical hopper is shown, rectangular or other shaped hoppers may be used. In this example, meter 16 is implemented as a scale to weigh powder 14 without also weighing hopper 12. Hopper 12 includes a first tube 18 that forms the barrel of the hopper and a funnel 20 at the bottom 22 of barrel 18 to funnel powder 14 out of hopper 12. Powder may be added to hopper 12, for example, through an inlet 24 at the top 26 of barrel 18 from a conduit 28. The flow of powder 14 out of hopper 12 may be controlled, for example, with a valve 30 at an outlet 32 at the bottom 34 of funnel 20.

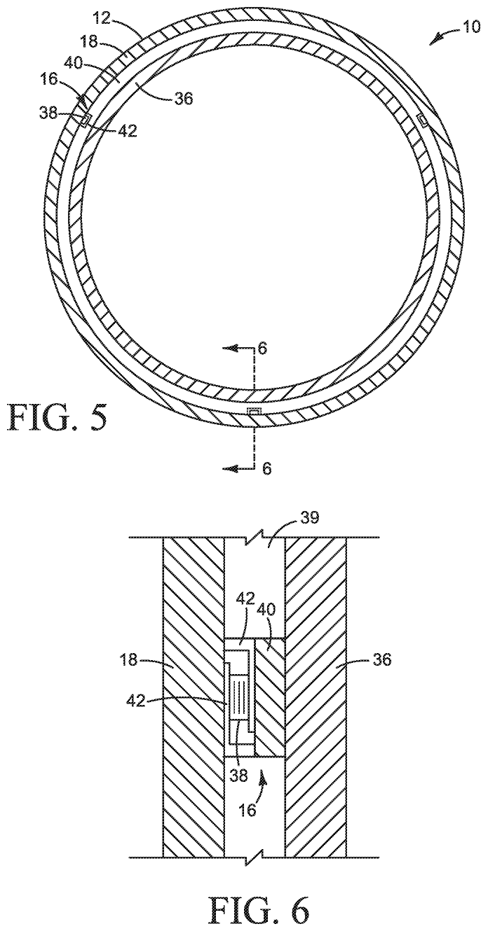

As best seen in FIGS. 4-6, scale 16 includes a second tube 36 that forms a cylindrical liner suspended vertically inside hopper 12 along barrel 18 to contain powder 14. Scale 16 also includes a sensor 38 to sense the weight of liner 36, which includes the weight of a column of powder 14 inside liner 36. Sensor 38 is shown in FIGS. 5 and 6. A column of powder inside liner 36 transfers its weight to the liner as a function of the height of the column. A taller column transfers more of its weight to the liner. Accordingly, the height of the column of powder 14 inside liner 36, and thus the powder fill level in hopper 12, may be determined by measuring the weight of liner 36. While the extent of weight transfer depends on the characteristics of the particular powder as well as the aspect ratio of the powder column, many build material powders used for additive manufacturing transfer at least 80% of their weight to the walls after two diameters of height for a cylindrical column. The weight transfer approaches 100% after about five diameters of height. Although it is expected that the relationship between column height and weight transfer used to determine the fill level for any particular powder will be established experimentally, it may be sufficient in some implementations to establish the relationship theoretically, by computer modeling for example.

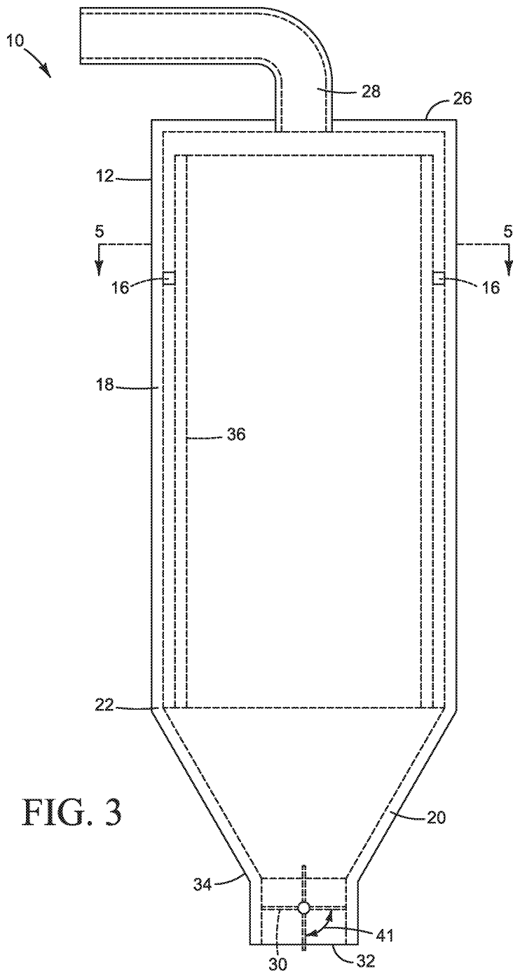

Barrel 18 and liner 36 form vertically oriented concentric cylindrical outer and inner walls, respectively, with the inner wall 36 suspended from the outer wall 18. These inner and outer walls are arranged with respect to one another such that powder 14 cannot enter the gap 39 between the cylindrical walls 18, 36. As shown in FIG. 3, valve 30 is movable between a closed position blocking the flow of powder 14 through outlet 32 and an open position allowing the flow of powder 14 through outlet 32, as indicated by a double headed arrow 41. An actuator for valve 30 is not shown.

In the example shown in FIGS. 2-6, liner 36 is suspended from hopper barrel 18 on a rigid suspender 40 and sensor 38 is implemented as a strain gauge or other suitable shear sensor attached to suspender 40. In this example, suspender 40 is configured as an annular ring completely surrounding liner 36 with three shear sensors 38 each positioned in a corresponding notch 42 in ring 40. More or fewer sensors 38 may be used and at different locations from those shown. Sensors 38 are depicted representationally in the figures.

FIG. 7 is a block diagram illustrating one example of a powder supply control system 44, for example to control a flow of powder into and out of a hopper 12 shown in FIGS. 2-6. Referring to FIG. 7, control system 44 includes a scale 16 and a controller 46. Scale 16 includes a rigid suspender 40 and a shear sensor 38, for example as shown in FIGS. 3-6. Controller 46 represents the programming, processor and associated memory, and the electronic circuitry and components needed to control the operative elements of a powder supply. In particular, controller 46 includes powder level programming 48 to compute or otherwise determine the level of powder in a hopper 12 based on signals from shear sensor 38. For one example, programming 48 may include a look-up-table (LUT) with entries correlating signals from shear sensor 38 to the level of powder 14 in a hopper 12. The correlation recorded in an LUT may be determined experimentally or theoretically. Programming 48 may include multiple LUTs each corresponding to a different type of powder. For another example, programming 48 may include an algorithm to compute the level of powder based on signals from shear sensor 38. The algorithm may be determined experimentally or theoretically.

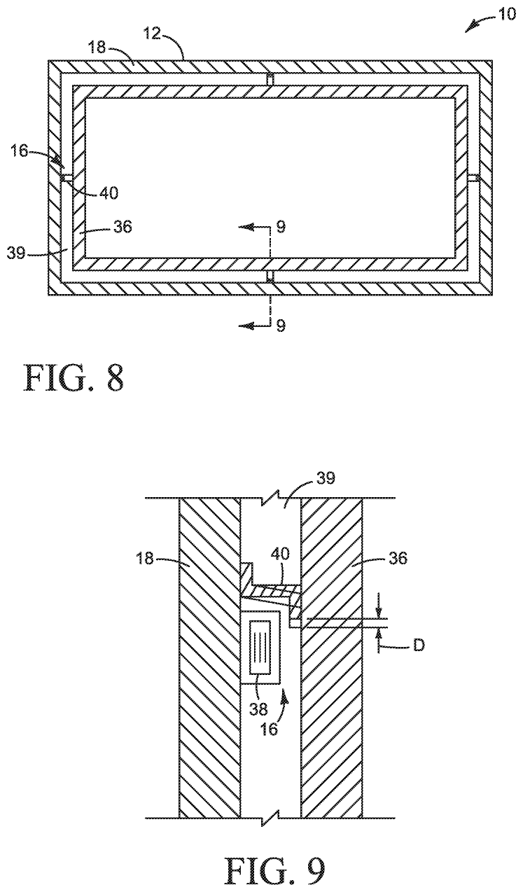

In the example shown in FIGS. 8 and 9, scale 16 includes a rectangular tube 36 lining a similarly rectangular tube 18 that forms the trunk of a rectangular hopper 12. Liner 36 is suspended from trunk 18 on a resilient suspender 40 and sensor 38 is implemented as a displacement sensor to measure a displacement D of liner 36 with respect to trunk 18. In this example, a group of four resilient suspenders 40 are spaced evenly around liner 36 with each suspender 40 configured as a leaf spring attached between liner 36 and trunk 18. A single sensor 38 may be used with one spring 40, as shown in FIG. 8, or multiple sensors 38 may be used with corresponding springs 40. More or fewer springs 40 may be used and at different locations from those shown.

FIG. 10 is a block diagram illustrating another example of a powder supply control system 44. Referring to FIG. 10, control system 44 includes a scale 16 and a controller 46. In this example, scale 16 includes a resilient suspender 40 and a displacement sensor 38, for example as shown in FIGS. 8 and 9. Controller 46 represents the programming, processor and associated memor3y, and the electronic circuitry and components needed to control the operative elements of a powder supply. In particular, controller 46 includes a powder level programming 48 to compute or otherwise determine the level of powder in a hopper 12 based on signals from displacement sensor 38. For one example, programming 48 may include a look-up-table (LUT) with entries correlating signals from displacement sensor 38 to the level of powder 14 in a hopper 12. The correlation recorded in an LUT may be determined experimentally or theoretically. Programming 48 may include multiple LUTs each corresponding to a different type of powder. For another example, programming 48 may include an algorithm to compute the level of powder based on signals from displacement sensor 38. The algorithm may be determined experimentally or theoretically.

“Level” in this context refers to any value representing the amount of powder in a receptacle including, for example, a volume of powder in the receptacle, a weight of powder in the receptacle, or a height of powder in the receptacle. Also, while powder level programming 48 is shown in the figures as an element of controller 46 distinct from scale 16, programming to determine the powder level may be part of scale 16.

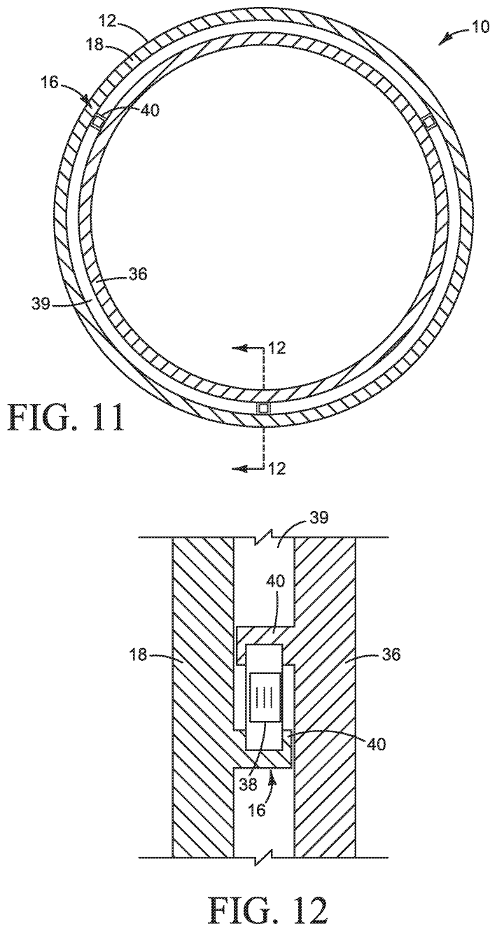

In the example shown in FIGS. 11 and 12, scale 16 includes a cylindrical liner 36 suspended from a hopper barrel 18 on three load cells 40 even spaced about the perimeter of liner 36. Each load cell includes an integrated sensor 38 to measure a load on the cell. Any suitable load cell could be used. Also, more or fewer load cells may be used and at different locations from those shown.

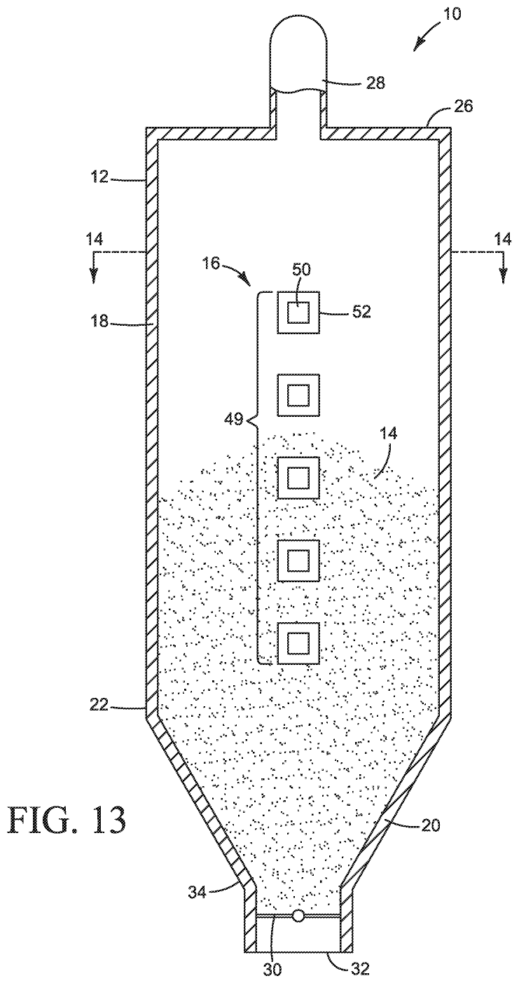

In the example shown in FIGS. 13-16, meter 16 is configured to measure a shear force exerted on the interior of hopper trunk 18 by a column of powder 14. Powder 14 is shown in FIG. 13. In this example, trunk 18 and thus the column of powder 14 is rectangular. Cylindrical or other shapes are possible. Meter 16 includes an array 49 of sensor panels 50 embedded in trunk outer wall 18 in an elastomeric or other suitably flexible suspension 52. In this example, a column of powder 14 in hopper 12 exerts a downward shear force on one or more panels 50 depending on the height of the column inside wall 18. A compression load cell or other suitable sensor 38 connected between panel 50 and a stationary bracket 54 affixed to outer wall 18 measures the shear force (if any) exerted by the powder on each panel 50. Sensor 38 may be configured to sense the presence of a powder shear on panel 50 alone, or to also sense the magnitude of the powder shear force on panel 50. The level of powder 14 in hopper 12 may then computed or otherwise determined based on signals from sensors 38. While it is expected that an array of multiple panels 50 will be desirable for most implementations, a single panel 50 may be sufficient in some implementations.

The examples shown in the figures and described above illustrate but do not limit the patent, which is defined in the following Claims.

“A”, “an” and “the” used in the claims means at least one. For example, “a meter” means one or more meters and subsequent reference to “the meter” means the one or more scales.

1. A powder holding system, comprising:
a receptacle having an interior to contain a column of powder; and
a meter to measure a shear force exerted on the interior of the receptacle by the column of powder.

2. The system of claim 1, where the meter includes:
a panel on the interior of the receptacle, the panel flexible in the direction of a shear force exerted on the interior of the receptacle by the column of powder; and
a sensor operatively connected to the panel to sense a shear force on the panel.

3. The system of claim 2, where:
the panel comprises multiple panels arrayed vertically along the interior of the receptacle, each panel flexible in the direction of a shear force exerted on the interior of the receptacle by the column of powder; and
the sensor comprises multiple sensors each operatively connected to a corresponding one of the panels to sense a shear force on the panel.

4. The system of claim 3, where the interior of the receptacle is defined at least in part by a wall and each panel is embedded in the wall.

5. The system of claim 1, where the meter includes a scale to measure a weight of powder in the receptacle without also measuring a weight of the receptacle.

6. The system of claim 5, where the scale includes:
a vertically oriented liner suspended inside the receptacle to contain at least some of the powder in the receptacle; and
a sensor to sense a weight of the liner including any powder contained by the liner.

7. The system of claim 6, where the liner is suspended from the receptacle and the sensor includes a sensor to measure shear between the liner and the receptacle.

8. The system of claim 6, where the liner is suspended from the receptacle and the sensor includes a sensor to measure a vertical displacement of the liner relative to the receptacle.

9. A powder holding system, comprising:
a hopper having a first tube and a funnel at one end of the first tube to funnel material out of the hopper;
a vertically oriented second tube suspended inside the first tube above the funnel; and
a scale to measure the weight of the second tube independent of the hopper.

10. The system of claim 9, where:
the second tube is suspended from the first tube; and
the scale includes a sensor to measure shear between the second tube and the first tube.

11. The system of claim 9, where:
the second tube is suspended from the first tube; and
the scale includes a sensor to measure a vertical displacement of the second tube relative to the first tube.

12. The system of claim 9, where the first tube and the second tube are arranged with respect to one another such that powder cannot enter a gap between the tubes.

13. The system of claim 9, comprising powder in the hopper filling the second tube to a height at least twice the diameter of the second tube.

14. A powder holding system, comprising:
a receptacle to hold a column of powder; and
a meter to measure a shear force exerted on an interior of the receptacle by a column of powder in the receptacle, the meter including one or both of:
a scale to measure a weight of powder in the receptacle without also measuring a weight of the receptacle; or
a panel on the interior of the receptacle, the panel flexible in the direction of a shear force exerted on the interior of the receptacle by the column of powder, and a sensor operatively connected to the panel to sense a shear force on the panel.

15. The system of claim 14, where the meter includes the panel and the sensor and:
the sensor comprises multiple flexible panels arrayed vertically along the interior of the receptacle, each panel flexible in the direction of a shear force exerted on the interior of the receptacle by the column of powder; and
the sensor comprises multiple sensors each operatively connected to a corresponding one of the panels to sense a shear force on the panel.
